(19) United States
(12) Patent Application Publication
(10) Pub. No.: US 2011/0006965 A1
(43) Pub. Date: Jan. 13, 2011

(54) Multi-Antenna Enclosure

(76) Inventor: Martin A. Kits van Heyningen, Newport, RI (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/832,351

(22) Filed: Jul. 8, 2010

Related U.S. Application Data
(60) Provisional application No. 61/224,638, filed on Jul. 10, 2009.

(51) Int. Cl. H01Q 1/52; H01Q 1/42; H01Q 21/30

(52) U.S. Cl. 343/841; 343/872; 343/853

(57) ABSTRACT

The present invention provides an improved single, light weight, compact integrated multi-antenna system for simultaneous reception and transmission of energy at multiple different frequencies without interfering with each other. The system includes an enclosure having a shield positioned at about its midpoint for secure placement of a first antenna on the top of the shield and second antenna on the bottom of the shield. The shield is fabricated and positioned to provide both a secure placement of the antennas and to block or attenuate the frequency signals of the first antenna to reach the second antenna and vice versa. The system further includes an interface coupled between the first and the second antenna to share data signals among each other.

### CROSS REFERENCES

This patent application claims the benefit of U.S. Provisional Application Ser. No. 61/224,638 filed Jul. 10, 2009, the contents of which are incorporated by reference herein.

### FIELD OF THE INVENTION

The present invention is generally related to the field of satellite communications and antenna systems, and is more specifically directed to combination of multiple antennas in a single enclosure.

### BACKGROUND OF THE INVENTION

Many transportation vehicles such as boats, automobiles, airplanes and the like have multiple antennas of different frequencies installed on them. However, it is a challenge to be able to install two antennas of different frequencies without interference between the antennas. It is very desirable to mount a radar antenna with other antennas such as a satellite TV antenna on a vehicle. However, radar arches are generally small, which makes it difficult to install two devices each having an unobstructed view towards the sky or horizon in a 360 circular area. Additionally, radar antenna transmits RF signals that can interfere with the satellite TV signals. The satellite TV dish antenna tends to cause blockage for the radar dish antenna and vice-versa.

A typical multi-antenna configuration is disclosed in U.S. Pat. No. 4,329,690 consisting of a GPS antenna 14 stacked on top of a TACAN antenna 16 which is stacked on top of a JTIDS antenna 18 as shown in FIG. 2. An isolation means such as choke rings 30 are provided to isolate GPS antenna 14 from the TACAN antenna 16 and choke rings 40 are provided to isolate TACAN antenna from JTIDS antenna 18.

U.S. Pat. No. 5,148,183 discloses a four-way antenna system having a radio antenna 12 attached to the top of the antenna body; a VHF antenna 20 also attached to top of the antenna body with bends at substantially right angles to form an open square with four sides such that the radio antenna 12 passed through the open space; a telephone antenna 28 attached to one side of the antenna body and a CB antenna 36 attached to the side opposite the side where the telephone antenna is attached. Although not shown, the patent claims to provide a means for isolating the antenna from each other to avoid interference between signals from each of the antenna.

U.S. Pat. No. 6,927,743 describes a marine antenna array including a contoured antenna assembly having a cowling 22 that houses at least two antennas 30 and 32 resonant in different frequencies as shown in FIG. 2. The antenna 30 is a multi-band antenna and projects through the cowling 22 generally along the axis. An antenna 32 is a GPS antenna mounted to a base plate in a perpendicular axis to the cowling 22.

None of the prior art as discussed above provide multiple antennas which receive and/or transmit electromagnetic signals of different frequencies completely enclosed in a single compact package at close proximity to each other without the different frequency signals interfering with each other. Further, none of the prior art as discussed above provides any means for sharing of the data among the antennas as provided by the different frequency signals. Thus, there is a need in the art to provide a single enclosure that accommodates such multiple antennas.

### OBJECTIVES AND SUMMARY OF THE INVENTION

One of the objectives of the present invention is to provide an improved means to install a multi-antenna system that combines two or more antennas to fit completely inside a single tight weight compact enclosed unit for easy installation while saving space and using the same footprint.

Another objective is to provide at least a first and a second antenna, each having its ideal orientation such that the frequency signals of the first antenna and the second antenna do not interfere with each other.

An even further objective is to provide at least a first and a second antenna such that the data signals derived from the first antenna and the second antenna are shared among each other.

The above objectives are accomplished by designing an enclosed unit having a shield positioned about a center surface of the enclosure, a first antenna affixed on the shield for transmitting and/or receiving signals at a first frequency and a second antenna mounted below the shield for transmitting and receiving signals at a second frequency. The shield functions to isolate the first antenna and the second antenna from each other in order to prevent interference of the first frequency signals with the second frequency signals. Furthermore, an interface is provided in the enclosed unit such that the data provided by the first frequency signal is shared by the second antenna and the data provided by the second frequency signal is shared by the first antenna.

In one embodiment, the first antenna is a satellite television antenna receiving SHF (typically 3-30 GHz) signals and the second antenna is a radar antenna transmitting and receiving UHF/SHF (typically 2-4 GHz or 8-12 GHz) signals.

In another embodiment, the first antenna is a satellite communications antenna capable of receiving and transmitting signals at different frequencies.

In another embodiment, the second antenna is a marine radar antenna receiving and transmitting radar frequency close to or at the receive frequency of the satellite television antenna.

### BRIEF DESCRIPTION OF THE DRAWINGS

FIG. 1 illustrates a schematic view of a multi-antenna system in accordance with one embodiment of the present invention.

FIG. 2 illustrates a schematic view of a multi-antenna system in accordance with another embodiment of the present invention

### DETAILED DESCRIPTION OF THE INVENTION

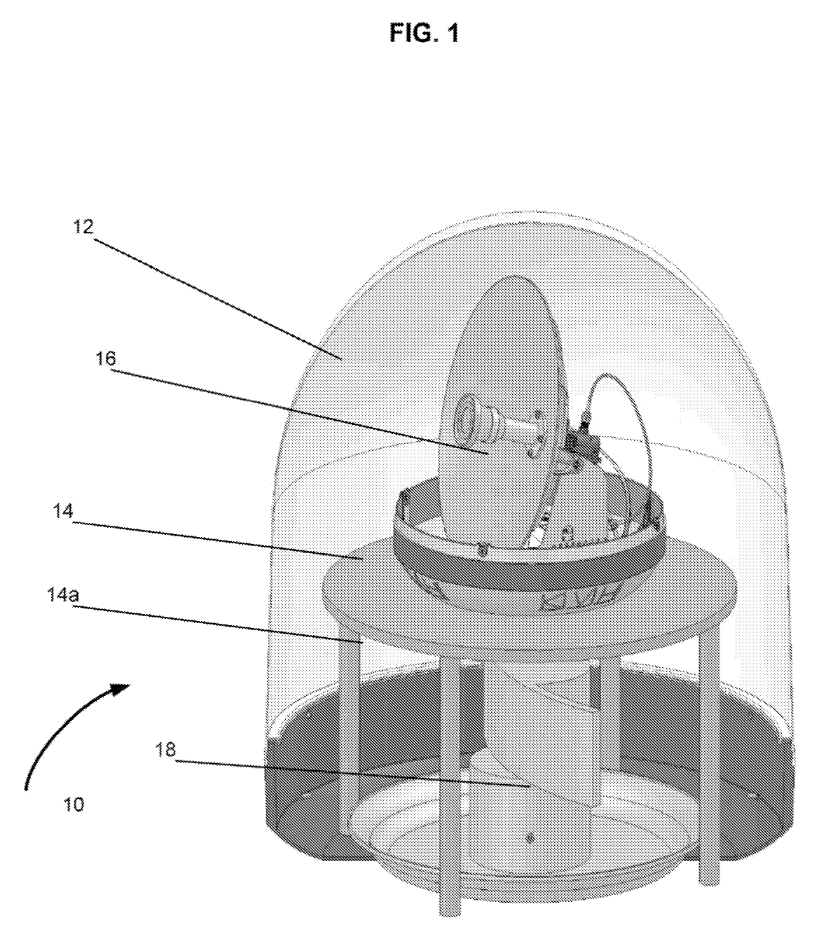

Referring to FIG. 1, there is illustrated a schematic view of a multi-antenna system 10 in accordance with an embodiment of the present invention. The system 10 includes a single enclosure, commonly known as a dome 12 having a shield 14 such as a mounting plate positioned preferably in a center surface of the dome 12. The shield 14 preferably includes support leg, 14a represented as vertical cylinders in FIG. 1. The system 10 also includes at least a first antenna 16 and at least a second antenna 18. As shown in FIG. 1, the first antenna 16 is preferably a satellite TV antenna system affixed on the mounting plate 14 with 360 degrees view of the sky. The diameter of the antenna 16 is in the range of 10 inches to 24 inches, preferably about 12.5 inches. The second antenna 18, preferably a radar system is placed below the mounting plate 14 with an unobstructed view of the horizon. The second antenna 16 has a diameter in the range of 12 inches to 24 inches, preferably having about 18 inches diameter array. In one embodiment, the satellite TV antenna 16 receives satellite TV signals with an electromagnetic frequency of preferably in the range of 8 GHz to 21 GHz. Depending on the frequency band, the radar antenna 18 sends and receives radar signals with an electromagnetic frequency in the range of either 2 to 4 GHz or 8 to 12 GHz.

In a preferred embodiment, the dome 12 may comprise of dimensions having a height in the range of about 20 inches to about 36 inches and diameter in the range of about 18 inches to about 26 inches. In one example, the footprint of each individual component, such as a typical satellite TV dish 16 is about 143 sq in and for a typical radar dish 18 is about 255 sq in, thus making for a total of about 398 sq in. However when placed together in the orientation as shown in FIG. 1, the footprint containing the both the television antenna and the radar consumes area of 290 sq in. In this case, the combined product needs only 73% of the original footprint, thus saving much needed space. Additionally, a typical radar output vertical beam width is in the range of about 12.5 degrees to about 25 degrees. Clearly, there is no direct path for RF energy from the radar to impinge on the satellite television antenna.

It is known to one skilled in the art that the emitted radar RF does reflect off of the objects in the beam path, but, the returned energy is very much lower than that emitted as the energy decays exponentially with distance traveled from source. The energy transmitted from the radar source transmits at about 4,000 watts of beam energy, which is very high. Thus, in order to prevent this energy beam from hitting the satellite TV antenna, the radar source/antenna is placed directly below the satellite TV antenna with the shield 14 in between as illustrated in FIG. 1. There will be no direct impact of the radar energy transmitted on the satellite TV antenna. The radar energy reflected/bounced back from another source (uncontrollable sources such as engine stack, metal structure and the like.) may potentially hit the satellite TV antenna besides the radar antenna, but this returned radar energy is very low as compared to the original transmitted level. By co-locating the two antennas concentrically as shown in FIG. 1, it is almost impossible for the direct energy to be fed from one antenna directly into another.

In fact, shape and material of the shield 14 can be selected to ensure that energy scattered with the radome/base shell poses no interference, as will be described in greater detail below.

Even though in FIG. 1, the shield 14 is illustrated as a mounting plate, one of ordinary skill in the art can appreciate that other types of protection means in different shapes and/or forms such as bowls, trays etc. may be provided as long as it is a weight bearing and an isolating device. In other words, the shield 14 should be capable of securely supporting the first antenna 16 and must be fabricated with a material to function to mitigate/prevent interference of the frequency signals of the first antenna 16 with the second antenna 18 and vice versa.

In one embodiment, the shield 14 is preferably fabricated of metal or a metalized plastic and functions to attenuate or block radar signals to interfere with the satellite TV signals and vice versa. The metal on the shield 14 tends to block RF energy by reflecting it away from the shield 14. In another embodiment, the shield 14 is preferably made of strength member combined with radar absorbent material such as foams, flat sheet forms from silicones and urethanes, plastics with additives, paints and the like to provide RF attenuation to absorb RF energy. The radar absorbent material on the shield 14 controls the RF beam by absorbing it as opposed to the metallic material that reflects or bounces back the RF energy. In both embodiments above it is noted that the support legs 14a of the shield 14 are simply structural support members that are transparent or largely transparent to RF energy.

As known to one skilled in the art, the wavelength of the energy is sensitive to type of material and also to the thickness of the material. The entire dome 12 may preferably be made of a material that is transparent or largely transparent to RF energy. In one embodiment, the entire dome 12 is preferably made of plastic material. In another embodiment, the entire dome 12 is preferably made of a glass or quartz. Also known to one skilled in the art, radome transmission loss is due to the insertion loss of a microwave signal passing through the radome wall. By making the radome wall thickness a factor of the wavelength of the signal, losses can be minimized. Typical factor is ½ signal wavelength for the wall thickness. So, in another embodiment of the present invention, the dome 12 could be constructed with one or more zones of various thicknesses based upon a ratio of the actual wavelength of the energy to best optimize for frequency transmittance. In a preferred embodiment, the bottom portion of the dome 12 where the radar antenna 16 resides, the thickness of the dome 12 may preferably have a second thickness value of about 0.16 inches. Based on the frequency of the radar and of the satellite antenna, the thickness of the dome 12 may be varied beyond the 25 degree point towards the top of the dome where the satellite antenna 14 resides. In a preferred embodiment, the top portion of the dome 12, where the satellite antenna resides, the thickness of the dome 12 may preferably have a first thickness value of about 0.18 inches to reduce loss at 18.3 to 20.2 GHz and to attenuate the radar signal.

In a preferred embodiment, the radar antenna 18 is marine radar. As known to one skilled in the art, the marine radar generally transmits high power levels of radio frequency close to or at the receive frequency of the satellite television antenna. The marine radar systems mainly consists of X band typically in the frequency range of 8 GHz to 12 GHz and S band typically in the frequency range of 2 GHz to 4 GHz.

In another embodiment of the present invention, the first antenna 16 is a satellite communication system having a diameter of preferably in the range about 18 inches to 24 inches that both transmits and receives signals in the frequency range of about 10 Ghz to about 15 Ghz. Preferably, the antenna 16 transmits at a frequency at about 14 to 14.5 Ghz and receives at a frequency of about 10.7 to 12.75 Ghz. In this embodiment, the both the satellite communication antenna 16 and the radar antenna 18 in the axis are transmitting and receiving signals, making the interactions more critical. However, by placing the two antennas in the orientation as discussed above with the shield 16 in between prevents the direct beam from the satellite communications antenna 16 into the radar antenna 18 and vice versa.

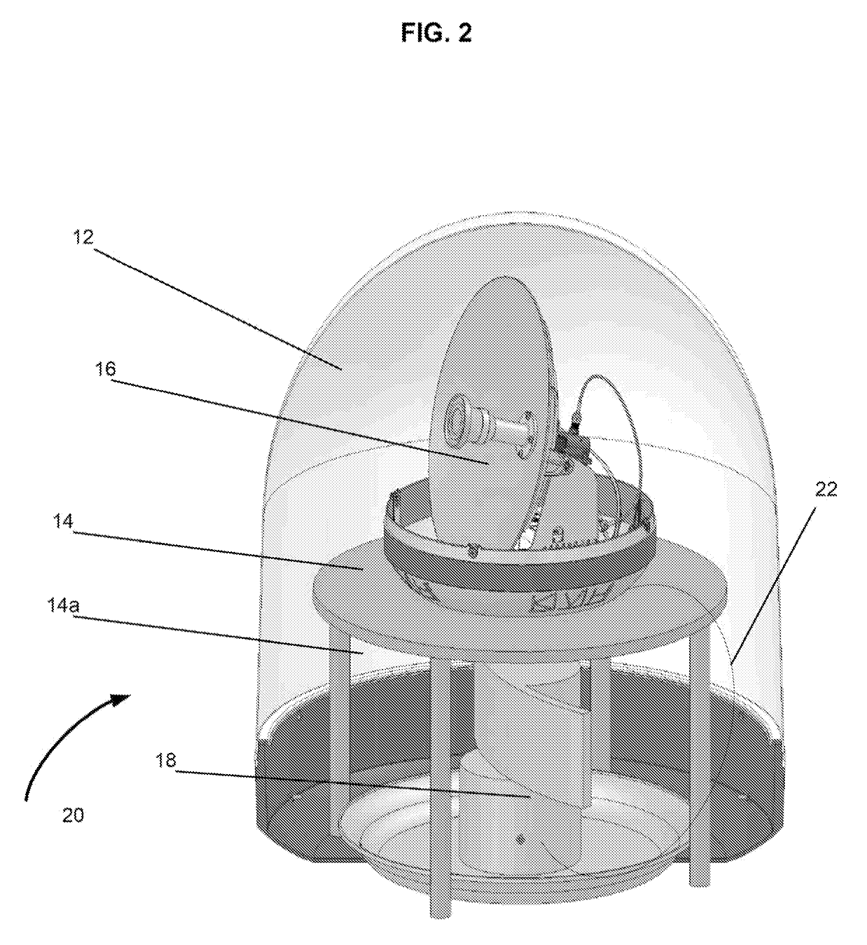

Referring to FIG. 2, there is shown a system 20 in accordance with another embodiment of the present invention. System 20 is similar to the system 10 of FIG. 1 with an additional interface 22 coupled between the antenna 16 and the antenna 18. The interface 22 is an electrical coupling that functions to allow data signals to be shared among the antennas 16 and 18. Such data signals may be information derived by the antenna's received signal, ancillary components (such as GPS devices, clock devices etc.) or programmed into the antenna's storage memory. For example, the antenna 16 may preferably include a GPS which continuously tracks the instant location of the antenna 16. Such GPS data may be stored and/or further processed by the antenna 16 which can be retrieved by the radar antenna 18. The radar antenna 18 may further use such data to enhance the radar image signal 18 by providing a map on the image. On the other hand, the functionalities of the radar signals produced by the radar antenna 18 may be provided to the antenna 16. A good example is an image of a blockage, such as a bridge; provided by the radar antenna 18 may be utilized by the antenna 16 as a warning that the antenna 16 may lose its signal due to blockage by the bridge.

The above embodiments of the present invention provides for a common single housing, which not only saves space but also guarantees optimal installation. As a result, the installer does not determine location of each antenna devices separately, since there is a fixed relationship between them. Also, with the shield placed between the antennas, it prevents frequency interference of the different frequency signals. Further, the features of the data provided by one antenna can be used and processed to enhance the features and/or functionalities provided by the second antenna.

Although, the embodiments described above with respect to satellite TV/satellite communications antenna and radar antenna, it is known to one skilled in the art that other antennas such as a GPS antenna, cell phone, CB radio and the like may be used without departing from the scope of the invention.

While the present invention has been described with respect to what are some embodiments of the invention, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A multiple antenna system comprising:
an enclosure having a shield positioned at about a midpoint of the enclosure;
at least a first antenna affixed on the shield for receiving signals in a first frequency range; and
at least a second antenna affixed below the shield for sending and receiving signals in a second frequency range, wherein said shield functions to prevent interference between the first and the second frequency signals.

2. The system of claim 1 wherein said shield is made of strength member and absorbent material, wherein said strength member reflects the received signals and said absorbent material absorbs the received signals.

3. The system of claim 2 wherein said strength member is one of a metal or metalized plastic.

4. The system of claim 2 wherein said absorbent material is at least one of a foam, flat sheets from silicones, urethanes, plastics with additives, and paint.

5. The system of claim 1 wherein said enclosure includes a top portion having a first thickness value and a bottom portion having a second thickness value.

6. The system of claim 5 wherein said first antenna is positioned on the top portion, wherein the first thickness value of the enclosure is a factor of the wavelength of the first frequency signal.

7. The system of claim 5 wherein said second antenna is positioned on the bottom portion, wherein the second thickness value of the bottom portion of the enclosure is a factor of the wavelength of the second frequency signal.

8. The system of claim 1 wherein said first antenna comprising a satellite TV antenna.

9. The system of claim 1 wherein said second antenna comprising one of a radar antenna, marine radar antenna, satellite communication antenna, GPS antenna, or CB antenna.

10. The system of claim 1 further comprising an interface coupled between the first antenna and the second antenna, said interface functions to share data signals between the first antenna and the second antenna.

11. A multiple antenna system comprising:
an enclosure having a shield positioned at about a midpoint of the enclosure;
at least a first antenna affixed on the shield for transmitting and receiving signals in a first frequency range; and
at least a second antenna affixed below the shield for transmitting and receiving signals in a second frequency range, wherein said shield functions to prevent interference between the first and the second frequency signals.

12. The system of claim 11 wherein said shield is made of strength member and absorbent material, wherein said strength member reflects the received signals and said absorbent material absorbs the received signals.

13. The system of claim 12 wherein said strength member is one of a metal or metalized plastic.

14. The system of claim 13 wherein said absorbent material is at least one of a foam, flat sheets from silicones, urethanes, plastics with additives, and paint.

15. The system of claim 11 wherein said enclosure includes a top portion having a first thickness value and a bottom portion having a second thickness value.

16. The system of claim 15 wherein said first antenna is positioned on the top portion, said first thickness value of the enclosure is a factor of the wavelength of the first frequency signal.

17. The system of claim 15 wherein said second antenna is positioned on the bottom portion, said second thickness value of the bottom portion of the enclosure is a factor of the wavelength of the second frequency signal.

18. The system of claim 15 wherein the first antenna comprising one of a satellite communication antenna, radar antenna, marine radar antenna, GPS antenna or CB antenna.

19. The system of claim 18 wherein the second antenna comprising one of a satellite communication antenna, radar antenna, marine radar antenna, GPS antenna or CB antenna.

20. The system of claim 11 further comprising an interface coupled between the first antenna and the second antenna, said interface functions to share data signals between the first antenna and the second antenna.
